(19) United States
(12) Patent Application Publication
(10) Pub. No.: US 2008/0068965 A1
(43) Pub. Date: Mar. 20, 2008

(54) DATA PROCESSING APPARATUS, RECORDER AND DISK WITH MULTIPLE STORAGE LAYERS

(76) Inventors: Yoshiho GOTOH, Osaka (JP); Hiroshi Hamasaka, Osaka (JP)

Correspondence Address: MARK D. SARALINO (MEI);RENNER, OTTO, BOISSELLE & SKLAR, LLP, 1621 EUCLID AVENUE, 19TH FLOOR, CLEVELAND, OH, 44115, US

(21) Appl. No.: 11/857,563

(22) Filed: Sep. 19, 2007

(30) Foreign Application Priority Data
Sep. 20, 2006 (JP) 2006-254674

(51) Int. Cl. G11B 7/20

(52) U.S. Cl. 369/94

(57) ABSTRACT

A data processing apparatus according to the present invention generates data to be written continuously on first and second recording layers of a recording medium. The first and second recording layers have first and second storage capacities, respectively. The data processing apparatus includes: a data storage in which the data to be written is split into, and stored separately as, first and second data, the first data having a data size that is smaller than the first storage capacity, the second data having a data size that is smaller than the second storage capacity; a communication section for getting the end address of a data recordable area of the first recording layer; a controller for adjusting the data size of the first data such that the beginning of the first data is written at the start address of the data recordable area of the first recording layer and that the end of the first data is written at the end address gotten; and an output section for outputting the first data, the data size of which size has been adjusted, and the second data.

### BACKGROUND OF THE INVENTION

1. Field of the Invention

The present invention relates to an image data processing apparatus for use in a service of downloading a video content onto a dual layer disk and also relates to an apparatus for writing such image data.

2. Description of the Related Art

To make a read-only DVD-Video disk (which will be simply referred to herein as a “DVD-Video disk”) to release it on the market, data compliant with the Cutting Master Format (CMF) is prepared in advance, a master is made based on that data, and then a DVD-Video disk is produced using that master. When a DVD-Video disk with two recording layers that have a combined storage capacity of 8.54 GB (=8.54×10⁹ bytes) is made, data compliant with the CMF is prepared for each of those two layers.

FIG. 12 shows the data structure of data compliant with the CMF (which will be referred to herein as “CMF data”). For example, this data structure is defined in DVD Cutting Master Format Specification Ver. 1.00: DVD Video and DVD ROM, found on Sep. 19, 2006 by searching the Internet.

<URL: http://www.dvdforum.org/tech-dvd_cutting_master_format_spec.htm>.

The CMF data is distributed in four files 101 to 104. Specifically, the DDVID.DAT file 101 stores CMF identification information. The VOBTBL.DAT file 102 stores a video manager and information about the locations of respective video title sets. The CONTROL.DAT file 103 stores information about control data to be written on a lead-in area. And the IMAGE.DAT file 104 stores image data to be written on a data recordable area.

FIG. 13 shows the layer structure of a dual layer DVD-Video disk (which will be simply referred to herein as a “disk”) and the arrangement of data when image data is written on the disk. First, the disk structure will be described.

This disk has a so-called “opposite track path”, in which a physical address is assigned to each sector of the disk.

Specifically, the disk includes a first layer (Layer 0, which will be referred to herein as “L0 layer”) consisting of a lead-in area 111, a data area 112 and a middle area 113 and a second layer (Layer 1, which will be referred to herein as “L1 layer”) consisting of a middle area 114, a data area 115 and a lead-out area 116. The physical addresses are assigned so as to increase rightward from the area 111 through the area 113 and then leftward from the area 114 through the area 116.

In a dual layer DVD-Video disk, the start address of the data area 112 of the L0 layer is fixed but the end address thereof is not fixed but determined by the size of the data to be written on the data area 112. The middle area 113 of the L0 layer is arranged right after the data area 112. That is why the beginning of the middle area 113 is also determined by the size of the data to be written on the data area 112.

The middle area 114 of the L1 layer is arranged symmetrically to the middle area 113 of the L0 layer. As a result, when viewed perpendicularly to the disk, the end of the data area 112 of the L0 layer and the beginning of the data area 115 of the L1 layer approximately agree with each other.

The end address of the data area 112 of the L0 layer and the start address of the data area 115 of the L1 layer are complements of two in the physical sector number space and are continuous with each other in the logical sector number space.

The end address of the data area 115 of the L1 layer is not fixed but determined by the start address of the data area 115 of the L1 layer and the size of the data to be written on the data area 115. The lead-out area 116 of the L1 layer is arranged right after the data area 115 of the L1 layer. That is why the beginning of the lead-out area 116 is also determined by the size of the data to be written on the data area 115.

In making a disk with such a structure, CMF data is prepared for each layer as described above. In this example, IMAGE.DAT 117 is provided for the data area 112 of the L0 layer and IMAGE.DAT 118 is provided for the data area 115 of the L1 layer. When the image data for the data areas of the respective layer are prepared, the arrangements of the middle area and the lead-out area are determined according to the sizes of those data and the conditions on the area arrangement described above.

In making a read-only DVD-Video disk for sale, the data to be bound-recorded has already been fixed. That is why the CMF data can be generated while adjusting the beginnings and ends of the respective areas described above.

However, such adjustment of the beginnings and ends of respective areas cannot be done when data is written on a write-once or rewritable optical disk with multiple recording layers. This is because the data area and middle area of the L0 layer and the middle area and the data area of the L1 layer are fixed on disks of those types.

For that reason, if content data that has been acquired by using a video content download service has such a big data size that the data needs to be written over multiple layers, then neither a write-once disk nor a rewritable disk can be used, which is a problem.

FIG. 14 shows the physical structure of a dual layer DVD-R disk. Just like the DVD-Video disk described above, the end address of a lead-in area (L-i) 121 is fixed. On the other hand, the end address of a data recordable area 122 of the L0 layer and the start address of the middle area 123 thereof are determined when the disk is produced.

As far as the address space of physical sector numbers is concerned, the end address of the data recordable area 122 of the L0 layer and the start address of the data recordable area 125 of the L1 layer are complements of two. On the other hand, in the logical sector number space, these two addresses are continuous with each other. That is why the end address of the middle area 124 of the L1 layer is also determined when the disk is produced. It should be noted that the lead-out area (L-o) 126 could be defined after data has been written.

In the dual layer DVD-R disk shown in FIG. 14, the middle areas 123 and 124 are fixed when the disk is produced. Therefore, unless the data size of image data coincides with the area size of the data recordable area 122 of the L0 layer, whenever image data is written on the L0 layer, an unused portion of the data recordable area 122 is left between the image data and the middle area 123. As a result, the logical sector address of the image data that has been written on the L0 layer and that of the image data that has been written on the L1 layer will be discontinuous with each other. In that case, a DVD player, which is designed to operate on the supposition that the logical sector addresses of the L0 and L1 layers are continuous with each other, could not play back the content properly.

Among other things, in dual layer DVD-R disks, the locations of the respective data recordable areas 122 and 125 of the L0 and L1 layers as viewed perpendicularly to the disk could sometimes shift from each other within a certain range due to some manufacturing error of the disk manufacturing equipment. Examples of the “manufacturing errors” include a track pitch error and a bonding error between two recording layers to be caused by a difference in equipment between the manufacturers. In writing data on the L1 layer of a dual-layer DVD-R disk, unless data has been written at a corresponding location on the L0 layer as viewed perpendicularly to the disk, the data cannot be written properly on the L1 layer. For that reason, in a dual layer DVD-R disk, the data recordable area of the L0 layer has a bigger size than that of the L1 layer with the potential manufacturing error between the L1 and L0 layers taken into account.

In the example shown in FIG. 14, the size of the data recordable area 122 of the L0 layer is greater than that of the data recordable area 125 of the L1 layer. Supposing a dual layer DVD-Video disk and a dual layer DVD-R disk have the same maximum storage capacity, the data recordable area of the L0 layer of the dual layer DVD-R disk is bigger than the data area of the L0 layer of the dual layer DVD-Video disk. Therefore, if image data were generated so as to be stored on a dual layer DVD-Video disk, then the unused portion would be left on a dual layer DVD-R disk when the image data is written on the dual layer DVD-R disk.

To avoid such a problem, a portion of the image data to be written on the L1 layer could be written in the unused portion of the recordable area right after the image data has been written on the L0 layer. According to the DVD-Video format, however, a cell, which is the minimum continuous unit of video data, should not be written beyond any boundary between multiple layers. That is why such an alternative method is not appropriate. To ensure compatibility with currently available methods of generating CMF data, it is necessary to provide CMF data, of which the cell is split at the boundary between the image data to be written on respective layers.

### SUMMARY OF THE INVENTION

An object of the present invention is to modify prepared image data by as simple a method as possible and get the data ready to be written on a write-once or rewritable recording medium when a content needs to be downloaded and stored on such a recording medium.

A data processing apparatus according to the present invention generates data to be written continuously on first and second recording layers of a recording medium. The first and second recording layers have first and second storage capacities, respectively. The data processing apparatus includes: a data storage in which the data to be written is split into, and stored separately as, first and second data, the first data having a data size that is smaller than the first storage capacity, the second data having a data size that is smaller than the second storage capacity; a communication section for getting the end address of a data recordable area of the first recording layer; a controller for adjusting the data size of the first data such that the beginning of the first data is written at the start address of the data recordable area of the first recording layer and that the end of the first data is written at the end address gotten; and an output section for outputting the first data, the data size of which has been adjusted, and the second data.

In one preferred embodiment, the controller adjusts the data size of the first data by inserting additional data by reference to the end address.

In this particular preferred embodiment, the start address of the data recordable area of the first recording layer has been determined in advance. And the controller inserts additional data, the data size of which is equal to a difference between the area size of the data recordable area of the first recording layer having the first storage capacity and the data size of the first data stored. The area size has been calculated based on the start and end addresses.

In another preferred embodiment, the first data includes content data and management information for managing the location of the content data. If the location of the content data has changed due to the insertion of the additional data, the controller updates the management information.

In this particular preferred embodiment, the recording medium stores unique identification information, the communication section gets the identification information, and the controller encrypts the content data using the identification information and generates scramble information, indicating that the content data has been encrypted, as a portion of the first data.

A recorder according to the present invention writes data that has been received from a server on first and second recording layers of a recording medium continuously. The recorder includes: a communication controller for sending the end address of a data recordable area of the first recording layer to the server and receiving first data, the data size of which has been adjusted by reference to the end address, and second data; and a drive controller for writing the first data, the data size of which has been adjusted, on the first recording layer and also writing the second data on the second recording layer.

In one preferred embodiment, the recording medium stores unique identification information, and the communication controller transmits the identification information to the server, and then receives the first data, which has been encrypted with the identification information and the data size of which has been adjusted.

In another preferred embodiment, a recording unit is defined for the recording medium. The first data includes encrypted content data, scramble information indicating that the content data has been encrypted, and management information for managing the location of the content data. The drive controller divides the encrypted content data into multiple recording units, writes the units separately, and also writes the scramble information on a header of each recording unit.

In still another preferred embodiment, the drive controller starts writing the first data at the start address of the data recordable area of the first recording layer such that the end of the first data is written at the end address.

A player according to the present invention reads data from a recording medium, on which the data has been written by the recorder of the present invention. The player includes: a controller that instructs when to start reading; and a drive controller for starting reading the first data at the start address of the data recordable area of the first recording layer and also starting reading the second data at the start address of the data recordable area of the second recording layer. As the end of the first data has been written at the end address, the drive controller starts reading the second data at the start address of the data recordable area of the second recording layer that is right next to the end address.

On a recording medium according to the present invention, data has been written continuously on first and second recording layers having first and second storage capacities, respectively, and each having a data recordable area. First data starts to be written at the start address of the data recordable area of the first recording layer and the end of the first data is written at the end address thereof. Second data starts to be written at the start address of the data recordable area of the second recording layer. The first data includes data for adjusting the data length of the first data.

The data processing apparatus of the present invention gets the end address of the data recordable area of the first recording layer, and adjusts the data size of the first data such that the end of the first data is written at the end address of the first recording layer, thereby generating processed first data. If such first data is written on the first recording layer, then the first recording layer will be stuffed with the data through the end. In that case, the address of the last data of the first recording layer will be continuous with that of the first data of the second recording layer. As a result, addressing can be done just as intended when the layers to access are changed from the first recording layer to the second recording layer during the playback operation.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

Portions (a), (b1), (b2) and (c) of FIG. 1 outline a method of adjusting the data size of image data to write the image data on a dual layer optical disk 19.

FIG. 2 shows an exemplary network configuration for devices to provide and receive the download services.

FIG. 3 shows the hardware configuration of a recorder 20 according to a first preferred embodiment of the present invention.

FIG. 4 shows the hardware configuration of the video server 30 of the first preferred embodiment.

FIG. 5 shows an exemplary directory/file structure for a video content to be recorded on a disk.

Portions (a), (b) and (c) of FIG. 6 show correlation between image data generated for a DVD-Video disk and image data that has been modified for a dual layer DVD-R or DVD-RW disk according to the present invention.

FIG. 7 shows the details of the first video title set.

Portions (a) and (b) of FIG. 8 show exemplary data of the volume/file structure to be stored on a sector-by-sector basis.

FIG. 9 is a flowchart showing the procedure of the processing to be done by the recorder 20 and the video server 30 of the first preferred embodiment.

Portions (a), (b1), (c), (d) and (e) of FIG. 10 outline the processing of writing image data on a dual layer optical disk 29.

FIG. 11 is a flowchart showing the procedure of processing to be done by the recorder 20 and the video server 30 according to a second preferred embodiment of the present invention.

FIG. 12 shows the data structure of data compliant with the CMF.

FIG. 13 shows the layer structure of a dual layer DVD-Video disk and the arrangement of data when image data is written on the disk.

FIG. 14 shows the physical structure of a dual layer DVD-R disk.

### DETAILED DESCRIPTION OF PREFERRED EMBODIMENTS

Hereinafter, preferred embodiments of a data processing apparatus according to the present invention will be described with reference to the accompanying drawings.

### Embodiment 1

Portions (a), (b1), (b2) and (c) of FIG. 1 outline a method of adjusting the data size of image data to write the image data on a dual layer optical disk 19. Portion (c) of FIG. 1 schematically illustrates a cross section of the dual layer optical disk 19. In the following example, the dual layer optical disk 19 is supposed to be a dual layer DVD-R disk. However, the dual layer optical disk 19 may also be a dual layer DVD-RW disk or any other recordable optical disk with multiple recording layers. Portions (a) and (b2) of FIG. 1 show image data 21 that has been prepared to be written on the L0 layer and image data 26 that has been prepared to be written on the L1 layer, respectively. On the other hand, portion (b1) of FIG. 1 shows image data that has been processed by the processing of this preferred embodiment.

As shown in portion (c) of FIG. 1, the L0 layer includes a lead-in area 11, a data recordable area 12 and a middle area 13, which are arranged in this order. The physical address of the start sector of the data recordable area 12 of the L0 layer is identified by S and the physical address of the end sector thereof by X. The middle area 13 has already been fixed.

In this case, the addresses are assigned along an opposite track path, and therefore, the physical addresses are assigned continuously from the middle area 13 of the L0 layer to the middle area 14 of the L1 layer. A data recordable area 15 is arranged to follow the middle area 14 of the L1 layer. In portion (c) of FIG. 1, a lead-out area 16 is already present. It should be noted, however, that there is no lead-out area 16 on the disk 19 before data is written there.

In portion (c) of FIG. 1, the start address of the data recordable area 15 is identified by X with a bar, which means that this address is a complement of two with respect to the end address of the data recordable area 12 of the L0 layer. In the following description, however, the start address of the data recordable area 15 will be identified by Y and the end address thereof by E.

The data to be written on the L0 and L1 layers has already been split into two, which are stored in a server to provide the data by a download service. As used herein, the “download service” means a service of allowing the user to get the data of a billed content (such as a video content) downloaded from a server over a network when he or she selects and agrees to pay for the content. For example, a system that allows the user to purchase a content by “video on demand” is a download service.

The image data 21 and 26 have a data structure compliant with the DVD-Video standard. The data sizes of these image data are smaller than the minimum area sizes of the data recordable areas 12 and 15 of the L0 and L1 layers.

These minimum area sizes are determined compliant with the standard for dual layer DVD-R disks. The standard defines the tolerance of manufacturing errors on the data recordable areas of manufactured disks. The “minimum area size” is defined in advance as the area size of a data recordable area that has become smallest due to a manufacturing error that is tolerated by the standard. That is why in dual layer DVD-R disks, the physical address at the end of the data recordable area of the L0 layer could be different between respective manufacturers or between manufacturing lots.

At the top of the image data 21, arranged is a piece of information 22 about a volume file structure, which is followed by DVD-Video data 23 for the L0 layer. In the logical sector space, the logical sector numbers (LSNs) are assigned on a sector-by-sector basis. In this example, the beginning of the image data 21 is identified by LSN0 and the beginning and end of the DVD-Video data for the L0 layer are identified by LSNa and LSNb, respectively.

At the top of the image data 26, arranged is DVD-Video data 27 for the L1 layer, which is followed by a volume file structure 28. It should be noted that since the opposite track path is adopted in FIG. 1, the logical sector numbers are assigned to respective physical sectors in the data recordable area 15 from the middle area 14 toward the lead-out area 16.

The processing method of this preferred embodiment includes the steps of (1) getting the end address X of the data recordable area 12 of the L0 layer in writing data on the L0 and L1 layers of the dual layer DVD-R disk and (2) adjusting the data size of the image data 21, which starts to be written on the data recordable area 12 of the L0 layer at the start address S, by reference to the end address X gotten such that the end of the image data 21 is written at the end address X of the data recordable area 12.

As used herein, “to adjust the data size” means inserting additional data (i.e., padding data) between the piece of information 22 about the volume file structure and the DVD-Video data 23 of the image data 21.

Portion (b1) of FIG. 1 shows the adjusted image data 24 to which the additional data 25 has been inserted. The data size of the additional data 25 is calculated by (X−S)−b, which corresponds to the difference between the area size of the data recordable area 12 of the L0 layer and the data size of the image data 21 for the L0 layer. The additional data may be dummy data, for example, which is entirely padded with zeros.

By inserting the additional data 25, the location of the DVD-Video data 23 shifts, and therefore, file management information that specifies the location of each file in the piece of information 22 about the volume file structure is updated. The information about the volume file structure in the image data 24 includes the updated file management information. If the file management information is modified such that the top of the DVD-Video data 23 shown in portion (a) of FIG. 1 is specified as the data location to access first, the playback processing is not affected even with the additional data 25 inserted. The management information will be described in detail later with reference to FIG. 8.

The image data 24 thus generated starts to be written on the data recordable area 12 of the L0 layer at the address S on the L0 layer. Meanwhile, the image data 26 starts to be written on the data recordable area 15 at the address Y on the L1 layer.

After that, the disk is subjected to finalizing processing. When the disk is finalized, the lead-out area 16 is defined at the address E, which indicates the end of the data recordable area 15 where data is stored on the L1 layer. As described above, the data size of the image data to be written on the L1 layer may be smaller than the area size of the data recordable area on the L1 layer on a blank disk.

When the finalizing processing is carried out, parameters of the volume structure stored on the L0 and L1 layers are also updated as will be described in detail later.

As described above, according to this preferred embodiment, the data size of image data is adjusted according to the end address of the data recordable area of each disk by inserting additional data thereto. Therefore, when data is written over the L0 and L1 layers consecutively, the logical sector address of the image data that has been written on the L0 layer becomes continuous with that of the image data that has been written on the L1 layer. As a result, the DVD player can read and play back content data just as intended.

The retention of the original image data shown in portions (a) and (b2) of FIG. 1, acquisition of the end address X, and adjustment of the data size of the image data due to the insertion of the additional data 25 are all carried out by a server that is installed to provide download services as will be described in detail later. After its data size has been adjusted, the image data may be downloaded onto a user's recorder and written on a dual layer DVD-R, for example. To get these types of processing done, the user's recorder needs to have the function of sending out the end address of the loaded dual layer DVD-R to the server.

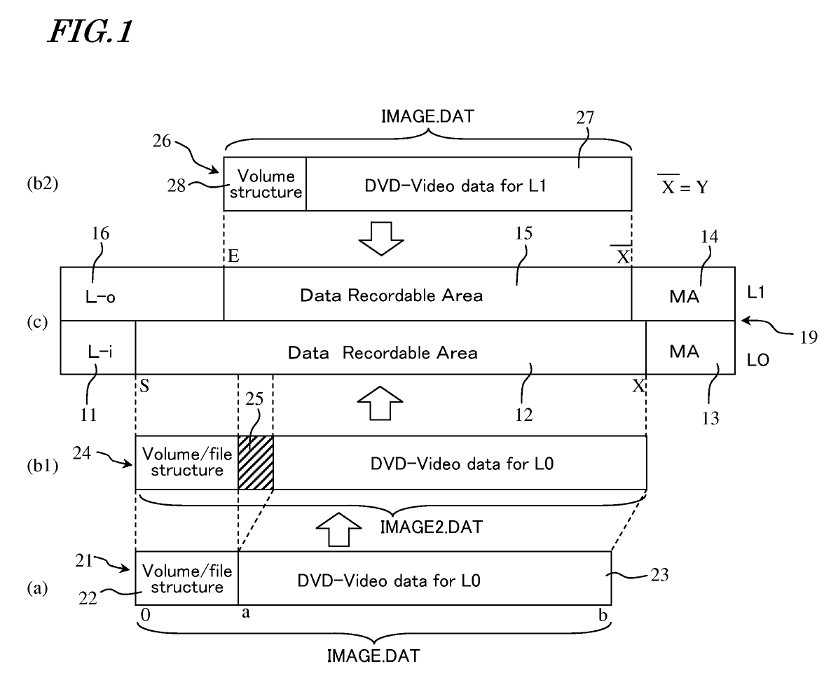

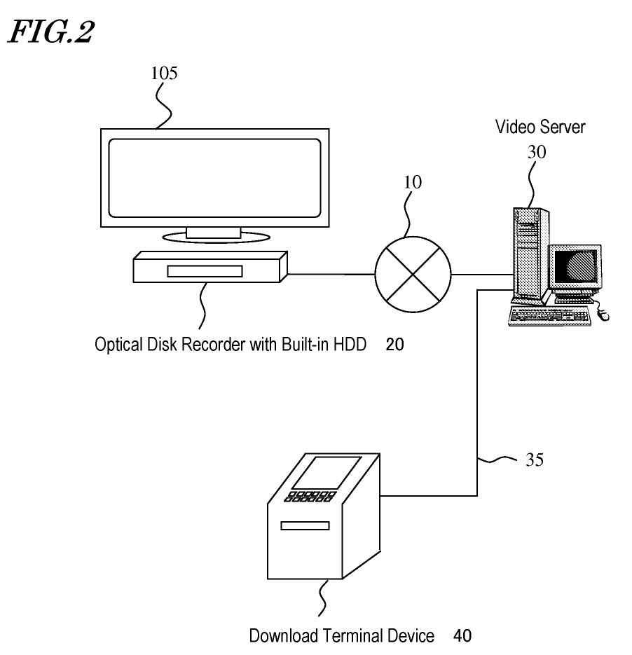

FIG. 2 shows an exemplary network configuration for devices to provide and receive the download services. An optical disk recorder 20 with a built-in HDD (which will be simply referred to herein as a “recorder” 20) and a video server 30 are connected together over the Internet 10. The video server 30 is installed by a download service provider, while the recorder 20 is located in a user's house.

Also, the video server 30 and a download terminal device 40 are connected together by way of a dedicated line 35. The download terminal device 40 may be installed at a railroad station store or a downtown shop. The user selects his or her favorite video content by operating the download terminal device 40, pays a specified amount of money, gets the video content recorded on a dual layer disk, and then receives the disk.

In the following example, the processing of this preferred embodiment will be described as being applied to the recorder 20 that is connected to the video server 30 over the Internet 10. However, even when the download terminal device 40 connected to the video server 30 by way of the dedicated line 35 is used, the same processing can be done as in the situation where the recorder 20 is used.

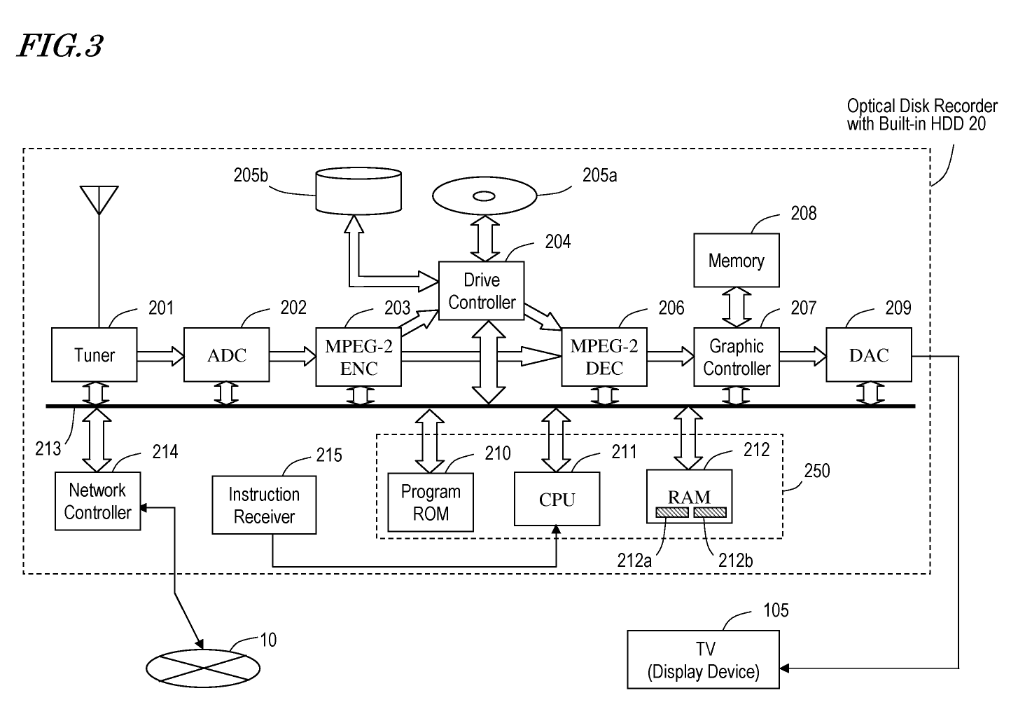

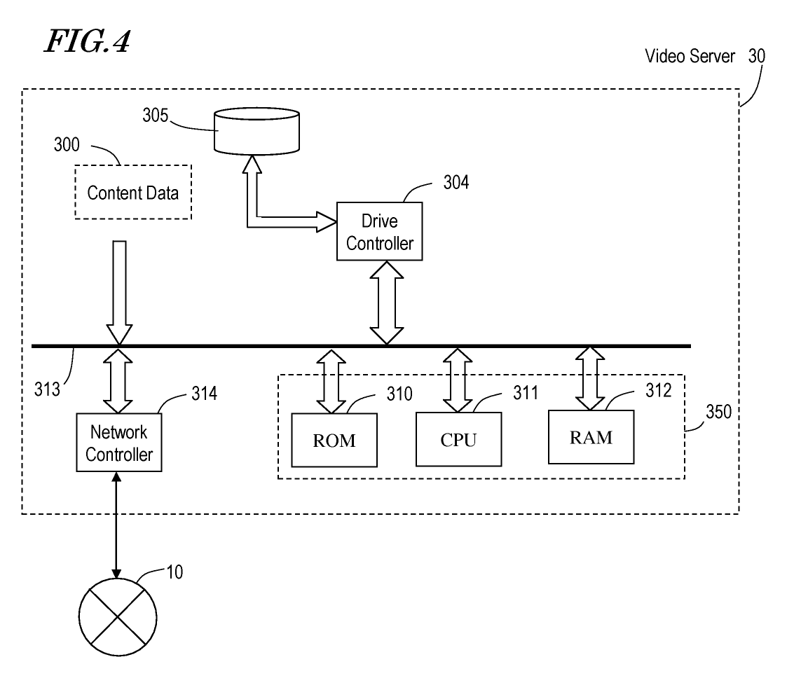

Next, specific hardware configurations of the recorder 20 and the video server 30 will be described with reference to FIGS. 3 and 4.

FIG. 3 shows the hardware configuration of the recorder 20 of this preferred embodiment. The recorder 20 is supposed to have the basic function of receiving a TV program signal from a broadcaster, generating a data stream based on the received signal, and then recording the data stream on either a dual layer DVD-R disk (which will be referred to herein as a “dual layer optical disk 205a”) or a hard disk 205a. This function will be referred to herein as a “program recording function”. The received TV program signal may represent either an analog broadcast or a digital broadcast. A configuration for recording an analog broadcast is shown in FIG. 3 as an example.

The recorder 20 also has the function of sending a predetermined request to the video server 30 that provides download services, receiving content data from the video server 30, and writing that received data on an optical disk with multiple recording layers. This function will be referred to herein as a “download recording function”. This download recording function is an essential function for the recorder 20 of this preferred embodiment but the program recording function described above is just an example and is not indispensable for the recorder 20 of this preferred embodiment.

Hereinafter, the components of the recorder 20 will be described.

The recorder 20 includes a tuner 201, an A/D converter 202, an MPEG-2 encoder 203, a drive controller 204, an MPEG-2 decoder 206, a graphic controller 207, a memory 208, a D/A converter 209, a CPU bus 213, a network controller 214, an instruction receiver 215, and a system controller 250. In FIG. 3, the dual layer optical disk 205a is shown inside the recorder 20. It should be noted, however, that the dual layer optical disk 205a is actually removable from the recorder 20 and does not form part of the recorder 20.

The system controller 250 consists essentially of a CPU 211, a program ROM 210 and a RAM 212 and controls the overall processing including signal flows inside the recorder 20. The other components operate under the instruction given by the system controller 250.

The program ROM 210, the CPU 211 and the RAM (which will sometimes be simply referred to herein as a “memory”) 212 are all connected to the CPU bus 213.

The program ROM 210 stores a software program for controlling the recorder 20. By reading a program 212a from the program ROM 210 and extending it on the RAM 212, the CPU 211 executes the program 212a, generates a control signal to realize the processing defined by the program and then outputs the control signal to the respective components over the CPU bus 213. The memory 212 has a work area for storing not only the program 212a but also data that is needed for the CPU 211 to execute the program 212a.

For example, if the user has gotten ready to be connected to the video server 30 in order to use the download service, the system controller 250 instructs the network controller 214 (to be described in detail later) to access the video server 30 over the Internet 10. Also, when the user gives a command to start or finish recording a program, the system controller 250 outputs an instruction to start or finish recording it.

The tuner 201 tunes itself to a particular channel of an analog radio wave that has been transmitted from a broadcaster, receives the radio wave, and then outputs the video and audio signals of the program to the A/D converter 202. In response, the A/D converter 202 converts the input signals into digital ones and supplies them to the MPEG-2 encoder 203. On receiving an instruction to start recording, the MPEG-2 encoder 203 (which will be simply referred to herein as an “encoder 203”) compresses and encodes the supplied digital data into the MPEG-2 format, generates an MPEG-2 program stream compliant with the DVD-Video standard (which will be simply referred to herein as a “program stream”) and passes it to the drive controller 204. This processing is continued until the encoder 203 receives an instruction to finish recording. The encoder 203 includes a buffer (not shown) for temporarily storing frame data and other data in order to perform the compression and encoding.

The drive controller 204 controls the processing of reading and writing data from/on the dual layer optical disk 205a using an optical head (not shown) and also controls the processing of reading and writing data from/on the hard disk 205b using a magnetic head (not shown).

The drive controller 204 sees if the dual layer optical disk 205a has been inserted while the user is using the download service. On determining that the dual layer optical disk 205a has been inserted, the drive controller 204 detects the terminal address X (see FIG. 1(c)) of the data recordable area of its L0 layer and sends the address to the video server 30 by way of the network controller 214. On the other hand, on receiving the image data that has been sent from the video server 30 by way of the network controller 214, the drive controller 204 writes the data on the dual layer optical disk 205a. Optionally, the data may be written on the hard disk 205b once and then written on the dual layer optical disk 205a.

Furthermore, in accordance with the instruction to start recording, the drive controller 204 performs recording starting processing. And when receiving the program stream after that, the drive controller 204 starts writing it on either the dual layer optical disk 205a or the hard disk 205b. Also, when the program stream stops being supplied after the instruction to finish recording has been received, the drive controller 204 ends the write processing and performs recording ending processing instead.

In this description, the drive controller 204 is supposed to control the exchange of information with both the dual layer optical disk 205a and the hard disk 205b. However, two drive controllers may be provided for the drive of the dual layer optical disk 205a and that of the hard disk 205b, respectively.

In playing back a content such as a program, on the other hand, the drive controller 204 reads data from the dual layer optical disk 205a or the hard disk 205b in accordance with the instruction to start reading that has been given by the system controller 250. Then, the drive controller 204 outputs the read data to the MPEG-2 decoder 206. The MPEG-2 decoder 206 (which will be simply referred to herein as a “decoder 206”) decodes the MPEG-2 compression-encoded data supplied, converts it into decompressed data and then passes it to the graphic controller 207. The graphic controller 207 is connected to the internal computer memory 208 and realizes an on-screen display (OSD) function. For example, the graphic controller 207 combines any of various menu pictures with the video and outputs the resultant synthetic image to the D/A converter 209. In response, the D/A converter 209 converts the input OSD synthetic image and audio data into analog data and outputs them.

The CPU bus 213 is a path for transferring signals in the recorder 20 and is connected to the tuner 201, the A/D converter 202, the encoder 203, the drive controller 204, the decoder 206, the graphic controller 207 and the D/A converter 209. In addition, the respective components of the system controller 250 described above are also connected to the CPU bus 213.

The network controller 214 has an interfacing function for connecting the recorder 20 to the Internet 10 and exchanges data over the Internet 10.

Examples of the data transmitted from the network controller 214 to the video server 30 include a content purchase request, a download request, and information about the end address X of the data recordable area 12 of the L0 layer. On the other hand, examples of the data received at the network controller 214 from the video server 30 include title list information of available contents and the image data of the purchased content. It should be noted that the image data has been split into image data to be written on the L0 layer and image data to be written on the L1 layer.

When a remote controller (not shown) as an accessory to the recorder 20 is operated by the user, the instruction receiver 215 receives a signal representing the operation instructed from the remote controller. For example, the instruction receiver 215 may receive a signal representing an instruction to get connected to the video server 30, an instruction to start a recording operation, or an instruction to end a recording operation from the remote controller. The instruction receiver 215 may further include an operating button on the recorder 20.

FIG. 4 shows the hardware configuration of the video server 30 of this preferred embodiment.

The video server 30 stores the CMF data of a plurality of video contents such as movies on a hard disk or any other storage medium. When the user finishes a video content purchasing procedure, the video server 30 transmits the CMF data of the purchased video content to the user's recorder 20. The data of the video content is written by the recorder 20 on a DVD-R, which will be treated as a read-only disk just like a DVD-Video disk.

If the data size of the video content data to transmit is too big to write it fully on anything but a dual layer DVD-R, the video server 30 provides a pair of CMF data to be written on the L0 and L1 layers of a dual layer DVD-R (which will be referred to herein as “CMF data for L0 layer” and “CMF data for L1 layer”, respectively).

If such a content has been purchased, the video server 30 requires the recorder 20 to transmit information about the dual layer DVD-R loaded in the recorder 20 (more specifically, address information about the end address X of the data recordable area 12 of the L0 layer). On receiving the address information about the end address X from the recorder 20, the video server 20 adjusts the data size of the CMF data for the L0 layer. More particularly, if the CMF data for the L0 layer starts to be written at the start address of the data recordable area of the L0 layer, the video server 30 adjusts the data size of the CMF data for the L0 layer by inserting additional data thereto such that the end of the CMF data for the L0 layer is written at the end address X gotten, thereby generating processed CMF data for the L0 layer. Thereafter, the video server 30 transmits the processed CMF data for the L0 layer and the CMF data for the L1 layer to the recorder 20.

Next, the configuration of the video server 30 will be described.

The video server 30 includes a drive controller 304, a hard disk 305, a bus 313, a network controller 314, and a system controller 350. That is to say, the configuration of the video server 30 is similar to that of the recorder 20. The video server 30 includes all components of the recorder 20 but those used exclusively to perform the program recording function.

When content data 300 is input externally to the video server 30, the drive controller 304 writes the content data 300 on the hard disk 305. This content data 300 is supposed to be CMF data. If its data size is relatively big, a pair of CMF data for the L0 and L1 layers of a dual layer DVD-R is stored. The CMF data is supposed to have been encrypted by the CPRM (Content Protection for Recordable Media) technique to enhance security. According to the CPRM technique, encryption is done using information unique to the target disk. As the piece of information unique to each disk, medium identification information (which is also called a “disk key”) stored in the BCA (burst cutting area) of the disk may be used. The BDA area is defined in the lead-in area. A barcode like pattern has been formed on the BCA area. And by using that barcode like pattern, a disk key to identify an optical disk can be recorded. This pattern has already been formed when the product is shipped. Examples of known recordable DVDs with the BCA area include DVD-R disks, DVD-RW disks and DVD-RAM disks.

If the content data 300 is mere MPEG encoded data, then the system controller 350 may perform the processing of generating CMF data and then the CMF data may be written on the hard disk 305.

The system controller 350 consists of a ROM 310, a CPU 311, and a RAM 312 and controls the overall processing including signal flows inside the video server 30.

The program ROM 310 stores a software program for controlling the video server 30 such as a content purchase processing program and a program for processing the CMF data for the L0 layer.

The CPU 311 executes the program that has been read from the program ROM 310 and extended on the RAM 312. In executing the program for processing the CMF data for the L0 layer, for example, the CPU 311 inserts the additional data to the CMF data for the L0 layer by reference to the address information received from the recorder 20, thereby generating processed CMF data for the L0 layer. Then the CPU 311 gets the data transmitted to the recorder 20 by the network controller 314. The network controller 314 has the same function as the counterpart 214 of the recorder 20, and the description thereof will be omitted herein.

In this preferred embodiment, the video server 30 is supposed to adjust the data size of the CMF data for the L0 layer. This is because as for video contents such as movies, their data should not be modified arbitrarily in many cases in order to protect their copyright.

If a conventional recorder is going to write the data of either a program being recorded now or a program that was recorded previously on a dual layer DVD-R in the DVD-Video format, then the recorder 20 generates the CMF data for the L0 layer by itself. In that case, the recorder performs either an encoding process or a re-encoding process such that the boundary between cells, which are minimum continuous units, is located at the end of the data recordable area of the L0 layer. It should be noted that the CMF data for the L0 layer is prepared in advance without performing the processing of inserting the additional data to the CMF data.

Next, the directory/file structure of the video content to be recorded on the disk will be described. After that, it will be described exactly what type of processing is carried out to insert the additional data 25 to the CMF data for the L0 layer.

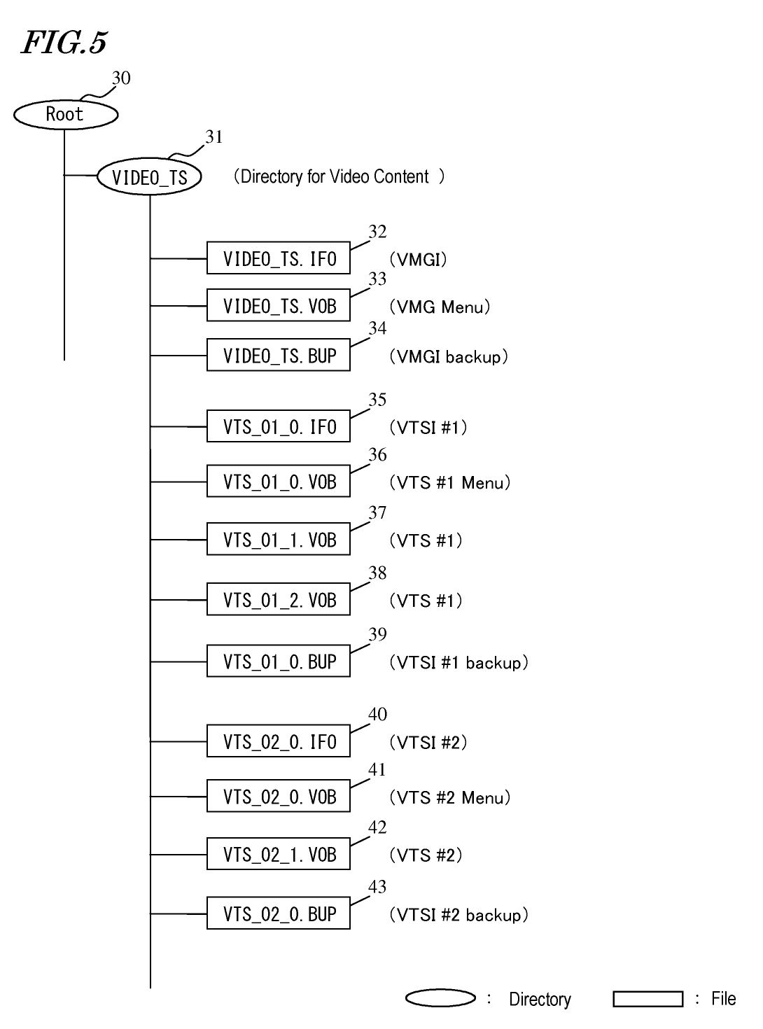

FIG. 5 shows an exemplary directory/file structure for a video content to be recorded on the disk.

As shown in FIG. 5, under the Root directory 30, there is a VIDEO_TS directory 31 for a video content. The respective files of the video content are recorded under the VIDEO_TS directory 31.

A VIDEO_TS.IFO file 32 stores video manager information VMGI for managing respective video title sets. A VIDEO_TS.VOB file 33 stores a video object for displaying a video manager menu VMG Menu. A VIDEO_TS.BUP file 34 stores a backup VMGI backup for the video manager information. The video manager consists of these files 32, 33 and 34.

A VTS_{—}01_{—}0.IFO file 35 stores information VTSI#1 about a first video title set. A VTS_{—}01_{—}0.VOB file 36 stores a video object for menu VTS#1 Menu for the first video title set.

The video object VTS#1 of the first video title set has been split into, and stored as, a VTS_{—}01_{—}1.VOB file 37 and a VTS_{—}01_{—}2.VOB file 38 for convenience sake. This split storage is done to make the size of each file smaller than a predetermined size. In this example, a video object of approximately 6 GB is split into, and stored as, two files such that the size of each of these two files is smaller than 4 GB.

If the files should be recorded compliant with the ISO9660 standard, too, the size of each file is preferably smaller than 1 GB. It should be noted that although the video object has been split into multiple files, those files are recorded adjacent to each other on the disk. That is why the two portions of the video object are never stored at two independent locations separately. A VTS_{—}01_{—}0.BUP file 39 stores a backup VTSI#1 backup of the first video title set information.

A VTS_{—}02_{—}0.IFO file 40 stores information VTSI#2 about a second video title set. A VTS_{—}02_{—}0.VOB file 41 stores a video object for menu VTS#2 Menu for the second video title set. The video object VTS#2 of the second video title set is stored in a VTS_{—}02_{—}1.VOB file 42. In this example, this video object has a size of approximately 2 GB.

A VTS_{—}02_{—}0.BUP file 43 stores a backup VTSI#2 backup of the second video title set information.

Portions (a), (b) and (c) of FIG. 6 show correlation between image data generated for a DVD-Video disk and image data that has been modified for a dual layer DVD-R or DVD-RW disk according to the present invention. Specifically, portions (a) and (b) of FIG. 6 show an example of image data generated for a DVD-Video disk. More specifically, portion (a) of FIG. 6 shows the arrangement of data in a video content and address pointers specified by the video manager, while portion (b) of FIG. 6 shows the arrangement of files in the video content and address pointers from FileEntry that is stored as file management information in the file structure. And portion (a) of FIG. 6 shows an example of image data that has been modified for a dual layer DVD-R disk.

The image data for the L0 layer and the image data for the L1 layer are prepared to be written on the logical address space of a dual layer DVD-Video disk. A UDF (universal disk format) volume structure 50 and a UDF file structure 51 are arranged in this order at the beginning of this logical address space and a video content is stored at a partition (i.e., the space between the volume structures) defined by the UDF volume structures.

Portion (a) of FIG. 6 corresponds to the example that has already been described with reference to FIG. 5. As shown in portion (a) of FIG. 6, arranged in this order are: video manager information (VMGI) 52 with a video manager menu (VMG Menu) 53 and a video manager information backup (VMGI backup) 54; a first video title set including video title set information (VTSI#1) 55, its menu (VTS#1 Menu) 56, a video object (VTS#1) 57, and a video title set information backup (VTSI#1 backup) 58; a second video title set including video title set information (VTSI#2) 59, its menu (VTS#2 Menu) 60, a video object (VTS#2) 61, and a video title set information backup (VTSI#2 backup) 62; and the UDF volume structure.

In FIG. 6, the dashed line 64 extending through portions (a) and (b) indicates the layer boundary that is set tentatively when the original image data is generated. According to this line 64, the first half of VTS#1 should be included in the image data for the L0 layer, while the second half thereof in the image data for the L1 layer. And these two halves are written on the respective layers.

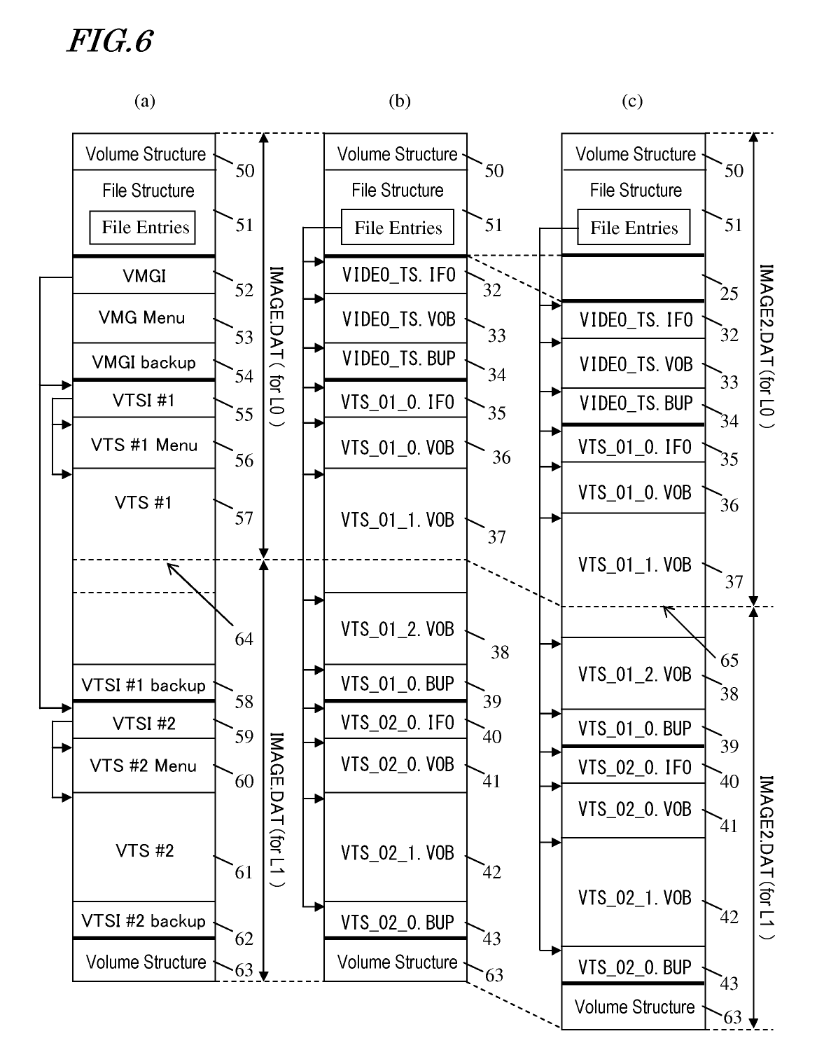

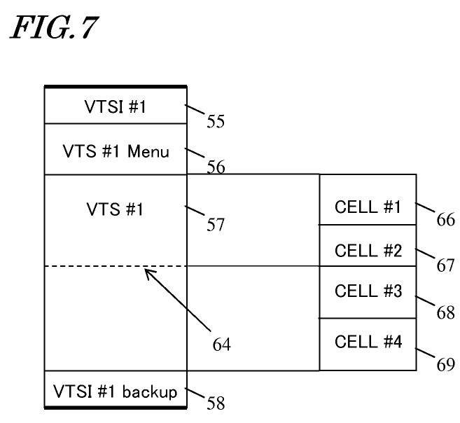

FIG. 7 shows the details of the first video title set. The video object (VTS#1) 57 consists of CELLS #1 through #4 66 to 69, which are minimum continuous playback units of video. According to the DVD-Video standard, no cell may cover multiple layers, and therefore, the cells have been divided on the layer boundary 64.

When a player to play a read-only DVD-Video (which will be simply referred to herein as a “DVD player”) is performing a playback operation, the DVD player jumps to respective video title sets by reference to the pointers to the video title sets that are included in the video manager information 52. In the video title set information 55 or 59 of each video data in the video title set, stored is the pointer information. By reference to this pointer information, the DVD player performs the playback operation. The DVD player gets the start address of the video manager information 52 using the file structure but does not have to access the file structure again after that. This is because the information that would require access is stored in the video content.

Portion (b) of FIG. 6 shows data files included in respective video contents. The arrangement of the data is the same as that shown in portion (a) of FIG. 6. However, the location information of the respective files is included in the file entries in the file structure 51. That is why respective files can be accessed by reference to these pieces of information.

Portion (c) of FIG. 6 shows the image data that has been modified by the system controller 350 of the video server 30 to be written on the dual layer DVD-R. The end of the data recordable area of the L0 layer of the dual layer DVD-R or DVD-RW disk is indicated by the dashed line 65.

The additional data 25 is inserted between the file structure 51 of the original image data for the L0 layer and the VIDEO_TS.IFO file 32. As a result, the VIDEO_TS.IFO file 32 and the other files that follow it are shifted backward. Consequently, the size of the modified image data IMAGE2.DAT for the L0 layer has increased from the original size by the additional data 25. Meanwhile, in the image data for the L1 layer, the arrangement of the data of the video content remains the same.

In the logical sector space consisting of the image data IMAGE2.DAT for the L0 and L1 layers, however, the locations of the data of the video content in the image data for the L1 layer are also shifted by the additional data. In addition, the partition size also increases by the additional data and the location of the volume structure 63 is also shifted by the additional data.

The start address of the VIDEO_TS.IFO file 32 may be detected not just by tracing the file structure but also by reference to the VOBTBL.DAT information of the CMF data.

It should be noted that even after the additional data has been inserted, the relative locations of the respective data in the video content remain the same. That is why there is no need to change the address information that is stored in the video manager and the video title sets shown in portion (a) of FIG. 6.

By adding the data size of the additional data to the location information (i.e., addresses) of the respective files defined by the file entries that are stored in the file structure 51, the location information of the respective files shifted is updated. In addition, the partition size registered with the volume structure 50 and the address information registered with the volume structure 63 are also updated.

Portions (a) and (b) of FIG. 8 show exemplary data of the volume/file structure to be stored on a sector-by-sector basis. The contents of FIG. 8 correspond to those of FIGS. 5 and 6. In the logical sector space consisting of image data, LSNs are assigned to respective sectors. The volume/file structure is compliant with the UDF.

As shown in portion (a) of FIG. 8, Beginning Extended Area Descriptor, NSR Descriptor, and Terminating Extended Area Descriptor are stored in LSN #16 through #18, respectively. These pieces of information are called a “Volume Recognition Sequence”, which indicates that this disk is compliant with the ECMA 167 standard that is a parent standard of the UDF standard.

Primary Volume Descriptor, Partition Descriptor, Logical Volume Descriptor, and Terminating Descriptor are stored in LSNs #32 through #35, respectively. These pieces of information are called a “Volume Descriptor Sequence”. Particularly, the location information of the partition is described by the Partition Descriptor and information about the beginning of the file structure is described by the Logical Volume Descriptor.

Anchor Volume Descriptor Pointer is stored in LSN #256. This pointer includes the location information of the Volume Descriptor Sequence. And this pointer is stored in LSN #256 and at the end N of the logical sector space. Also, each descriptor includes the logical sector number at which the descriptor is stored. That is why if a descriptor has shifted, its logical sector number needs to be changed. In this example, LSNs #0 through #256 define the volume structure, while LSNs #272 through #288 define the file structure.

In LSN #272, stored is the file entry of the Root directory, which represents the location information of the Root directory. According to the UDF, a file set descriptor is actually stored as the first piece of information of a file structure but is omitted from FIG. 8. In LSN #273, stored are the Root directory and the location information of the file entry of the VIDEO_TS directory, which is a sub-directory of the Root directory. In LSN #274, stored are the file entry of the VIDEO_TS directory and the location information of the VIDEO_TS directory. In LSN #275, stored are the VIDEO_TS directory and the location information of the file entries of respective files registered with this directory.

And in LSNs #276 through #288, stored are the file entries of the respective files that are registered with the VIDEO_TS directory. In this case, the file location information included in each file entry is stored in the forms of Extent length and Extent Position, which is information about the start address of the extent.

As already described with reference to FIG. 7, when image data is stored on the dual layer DVD-R or DVD-RW disk, the locations of the files registered with the VIDEO_TS directory are shifted by the additional data 25. That is why in the location information of the respective files pointed to by the respective file entries that are stored in the LSNs #276 through #288, the value stored as the Extent Position is increased by the size of the additional data 25 and updated. In addition, since the size of the partition is also increased, the location information of the partition as described by the Partition Descriptor in the LSN #33 is updated, too. Furthermore, since each descriptor is supposed to store the number of the logical sector, where the descriptor itself is stored, in Tag ID, the logical sector number N in the Anchor Volume Descriptor Pointer to be stored last is also updated.

Another way to update the file location information for shifted files is to update the location of the partition. The information to specify the location of the partition, which is stored in the Partition Descriptor is updated so that the location of the partition is shifted due to the insertion of the additional data. In this case, each piece of file location information is not updated. This is why each file is addressed by using logical block number which is relative address from the top of the partition, although the logical block number is not described in FIG. 8.

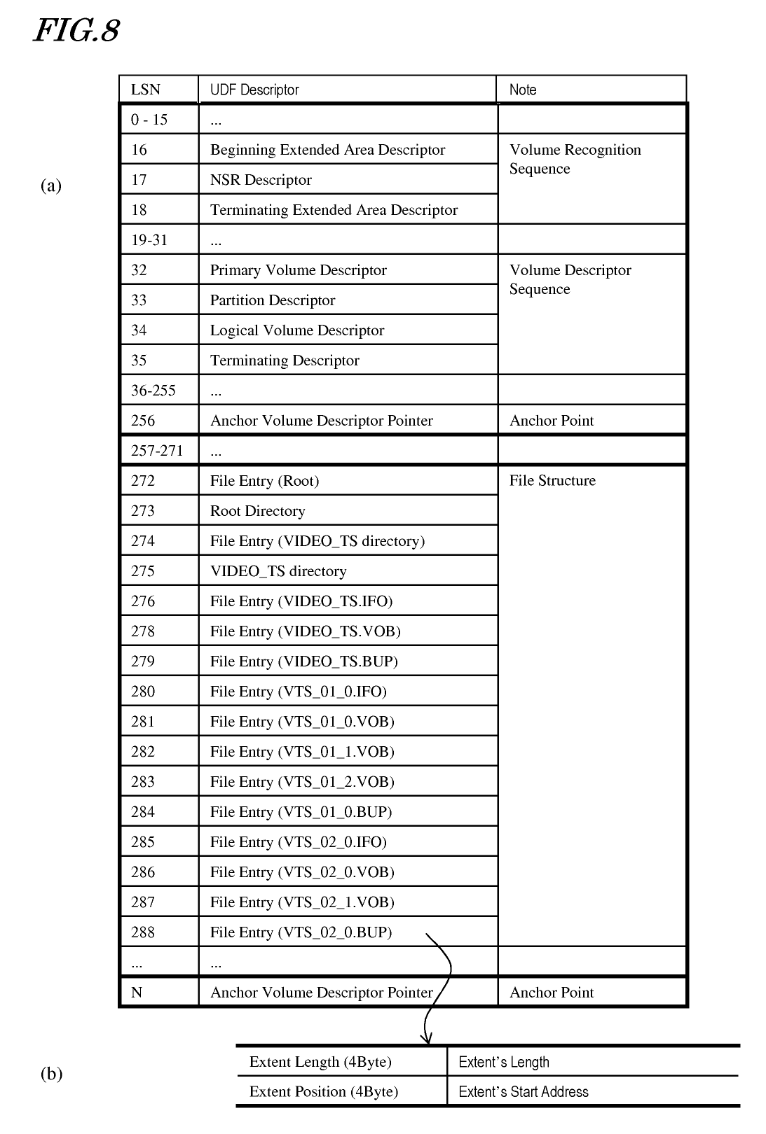

FIG. 9 shows the procedure of the processing to be done by the recorder 20 and the video server 30 of this preferred embodiment.

In FIG. 9, the processing steps on the left-hand side are performed by the recorder 20, while those on the right-hand side are performed by the video server 30. Also, the processing shown in FIG. 9 is not started until the user has gotten connected to the video server 30 using the recorder 20 and until connection is established between the recorder 20 and the video server 30.

First, in Step S1, by operating the recorder 20, the user selects a title to purchase among the title list of available contents. The title list information may be transmitted from the video server 30 to the recorder 20 when the recorder 20 is connected to the video server 30 or may have been acquired in advance by the recorder 20 over the Internet 10, for example.

In any case, the information about the title that has been selected by the user as the content to purchase is sent out as a download request to the video server 30 over the Internet 10.

Next, in Step S2, when the user inserts a dual layer DVD-R disk to record the content thereon, the drive of the recorder 20 (i.e., the drive controller 204) detects the disk loaded and performs startup processing to make the disk ready to write data on.

Subsequently, in Step S3, the drive controller 204 reads information from the lead-in area of the dual layer DVD-R disk loaded, gets the end address X of the data recordable area of the L0 layer and the disk key, and sends these pieces of information to the video server 30.

Meanwhile, in Step S4, the video server 30 receives the information about the title selected by the user and searches for its associated image data in accordance with the information.

Then, in Step S5, the video server 30 shifts, by reference to the end address X received, the locations of the data of the video content in the image data for the L0 layer among the data that has been searched for in the processing step S4, thereby processing the image data for the L0 layer.

Thereafter, in Step S6, the video server 30 performs predetermined types of processing of generating and issuing a decryption key using the disk key received to decode the data that has been encrypted in advance by the CPRM technique. According to the CPRM technique, the decryption key is made out of the disk key, and therefore, the image data stored in the video server 30 does not have to be encrypted for every disk. The encrypted data may be used for a plurality of disks. And the decryption key generated is stored at a predetermined location in the image data.

Next, in Step S7, the video server 30 modifies the file entries of the respective files of the video content and updates the location information for the shifted video content. The video server 30 also updates the partition size and the anchor volume descriptor pointer stored in the logical sector number N as pieces of information about the volume structure. As a result of this processing step, image data for the L0 layer that has been optimized to be written on the dual layer DVD-R disk can be obtained.

Next, in Step S8, the video server 30 transmits the image data that has been modified in the previous processing steps S5 and S6 to the recorder 20.

Subsequently, in Step S9, the recorder 20 receives the image data. Finally, in Step S10, the recorder 20 writes the received image data on the dual layer disk. Once the written data has been verified, this disk is provided for the user.

In the foregoing description, the original image data is supposed to be CMF data. However, the present invention is in no way limited to that specific preferred embodiment. Although multiple image data are supposed to be prepared for respective recording layers in the preferred embodiment described above, single continuous data may also be prepared. This is because the layer boundary can be specified by any other piece of information. For example, the layer information may be stored in CONTROL.DAT or the cell boundary may be found by searching the DVD-Video format data.

Next, as shown in portion (b1) of FIG. 1, additional data 25 is inserted into the CMF data 24 that has been encrypted by the CPRM technique. This processing step is performed by the video server 30. As the additional data 25, media key block data may be written. The media key block is data in which the disk key has been encrypted with all device keys issued by licensers and which could be called “cryptographic key chain” so to speak.

Video object data may be prepared by encoding the original material data in an MPEG-2 compression format, for example. If the data is provided as a package or by a download service, however, the data should have high image quality. That is why it would take a lot of time to get the encoding process done and the data could not be encoded in real time. For that reason, the cell boundary needs to be pre-defined by the layer boundary. Also, even if the image data stored in the video server 30 were compliant with a non-CMF format, it would be effective to modify the image data according to a parameter of the dual layer DVD-R disk used.

It should be noted that the data recordable area of the L0 layer of a dual layer DVD-R or DVD-RW disk has a bigger size than that of a dual layer DVD-Video disk. That is why if data that would not require the entire combined capacity of 8.54 GB of a dual layer DVD-R or DVD-RW disk but would need a space that is somewhat smaller than the maximum capacity by several tens of MB, for example, is used when a video content is produced to make a dual layer DVD-Video disk, no re-encoding would be needed in providing a download service.

Optionally, another video content compliant with the DVD-Video format may be recorded as the additional data. The additional data normally has a size of several tens of MB, and therefore, a short video content could be recorded as well. In that case, file management information for those additional files should also be added to the file structure.

If necessary, file management information compliant with the ISO 9660 standard could be added to the file structure.

Since the area between the end of a video content and the volume structure to be recorded at the end of the logical sector space is usually vacant, data for use in a personal computer (PC), for example, may be added to that area such that the data recordable area of the L1 layer can be made full use of.

As for download terminals, only disks, of which the end address X of the data recordable area of the L0 layer is a predetermined one, may be used. As an object of the present invention is to make download services available at low costs for various purposes, the same effect is also achieved even in that case. This is because download services are particularly required to get ready to provide titles in numbers that are too large for a normal shop to provide. For that reason, in the CMF format data that were used to produce DVD-Video disks that have gone on public sale, the image data to be stored in the L0 layer is usually different from one title to another. According to this preferred embodiment, there is no need to re-encode these CMF format data but just dummy data needs to be inserted and encryption should be done by a predetermined encryption technique, thus contributing to cutting down on the cost of authoring.

### Embodiment 2

In the first preferred embodiment of the present invention described above, the data size of CMF data for L0 layer is adjusted. And that CMF data is supposed to have been encrypted by the CPRM technique.

A second preferred embodiment of the present invention to be described below is a method of writing data in a situation where the CMF data has been encrypted by a different encryption method, not the CPRM technique.

Examples of known encryption methods suitable for recordable disks include not just the CPRM technique but also AACS (advanced access content system) and CSS (copy scrambling system). Hereinafter, it will be described what type of processing needs to be carried out in addition to the processing steps of the first preferred embodiment when data is encrypted by the CSS technique. If the CSS technique is adopted, encryption is done using a piece of information that is unique for each disk as a target of recording.

As the piece of information unique to each disk, medium identification information stored in the lead-in area of the disk (i.e., the disk key) may be used.

No disk keys are available from any DVD-R on the market. For that reason, when a DVD-R is used, a new type of disk for which a unique disk key has been defined will be needed. Or a new type of disk on which a valid key has been recorded in advance may be needed. This preferred embodiment will be described on the supposition that the disk is provided with the disk key to use already recorded in the lead-in area as an example of the CSS encryption.

Hereinafter, the second preferred embodiment of the present invention will be described with reference to portions (a) through (e) of FIG. 10. The processing of this preferred embodiment may be carried out using the recorder 20 and the video server 30 of the first preferred embodiment described above. Thus, in the following description, the processing of this preferred embodiment is also supposed to be carried out using the same recorder 20 and the same video server 30.

Portions (a), (b1), (c), (d) and (e) of FIG. 10 outline the processing of writing image data on a dual layer optical disk 29.

First, portion (c) of FIG. 10 shows the storage location of a disk key 91 on the disk 29. In this example, the disk key 91 is stored in the lead-in area that is an inner area on the disk 29.

Portion (a) of FIG. 10 shows the image data 21 that has been prepared so as to be written on the L0 layer. Meanwhile, the image data to be written on the L1 layer is the same as that shown in portion (b2) of FIG. 1, and the description thereof will be omitted herein.

As shown in portion (a) of FIG. 10, the DVD-Video data for L0 layer 23 includes a number of video objects (VOBs), each of which includes a plurality of video object units (VOBUs) 80. The VOBU 80 is a data unit including video data, the size of which is represented by a video playback duration of 0.4 through 1.0 second.

The VOBU 80 is a set of multiple packs, which form the low-order layer of an MPEG program stream. There are multiple different types of packs, including video packs identified by V and audio packs identified by A. These packs have a constant data size (which is also called a “pack length”) of 2 KB (=2,048 bytes).

For example, the video pack (V) 81 includes a pack header 82 and video data 83. The video data 83 may or may not have been encrypted.

The recorder 20 sends the disk key 91 shown in portion (c) of FIG. 10 to the video server 30.

Portion (d) of FIG. 10 shows CMF data 84, of which some of the video packs have been encrypted with the disk key 91. With the disk key 91, the video server 30 encrypts the video data 83. The decryption key may be stored in the content (e.g., in the VIDEO_TS.IFO file) and read by the recorder 20 when the content is played back.

To guarantee a high degree of security, every video data is preferably encrypted. In that case, however, it would take a lot of time to get the decoding process done. That is why the video data stored in only 50 to 60% of the video packs need to be encrypted actually.

In the CMF data 84, the DVD-Video data for the L0 layer 85 includes both non-encrypted video packs 86 and encrypted video packs 87 alike.

The encrypted video pack 87 includes a pack header 88 and video data 89 that has been encrypted with the disk key 91. It should be noted that scramble information 90 is included in the pack header 88 of the video pack 87. The scramble information indicates whether or not the video data of that pack has been encrypted. For example, if the scramble information is one, it may mean that the video data has been encrypted. On the other hand, if the scramble information is zero, it may mean that the video data has not been encrypted.

It should be noted that even if the video data had been originally encrypted by the CPRM technique, that video data could also be decoded once and then encrypted again by the CSS technique using the disk key 91. This is because such processing of changing the encryption methods can be done in real time even on video data with a relatively big data size that it would take approximately two hours to play back. Consequently, such a change of encryption methods would pose no obstacle to getting the processing done when the video data of the user's selected title is transmitted.

Next, as shown in portion (b1) of FIG. 10, additional data 25 is inserted into the CMF data 84 and then CSS encryption is carried out. This processing step is performed by the video server 30.

Meanwhile, the CMF data 84, the data size of which has been adjusted by inserting the additional data 25 thereto, is written on the data recordable area 12 of the disk 29 with no unnecessary space or no unwritten data left. This processing step is performed by the recorder 20. These processing steps are performed just as already described for the first preferred embodiment.

Portion (e) of FIG. 10 shows in detail a sector portion on which encrypted video packs have been written. The disk 29 has a sector structure in which there are a number of recording units 92, each consisting of a sector header 93 and a sector 94. The sector size of each sector is 2 KB, which is equal to the data size of a video pack.

In the sector 94 shown in portion (e) of FIG. 10, stored is the video pack 87 as it is. That is to say, the scramble information 90 and the encrypted video data 89 included in the video pack 87 are stored in the sector 94.

The recording processing of this preferred embodiment is partly characterized by writing scramble information 95 on the sector header 93, too, after the data size of the image data to be written on the L0 layer has been adjusted with the insertion of the additional data 25. The scramble information 95 is a copy of the scramble information 90 and their contents are identical with each other.

The scramble information 95 is stored in the sector header 93 in order to control the drive's reading. A drive that is going to read data cannot determine whether the data has been encrypted or not. Meanwhile, even if the data has been encrypted, it is not preferable that content data is read unconditionally. That is why a conventional drive compliant with the DVD standard is designed so as not to read the sector that follows the sector header 93 if the scramble information stored in the sector header 93 is one but to read the sector only when the scramble information is zero.

According to this preferred embodiment, after the size of the image data to write has been adjusted with the insertion of the additional data, that scramble information has the same value as the other scramble information indicating whether or not the data has been encrypted, thereby controlling reading operation of the drive. If the sector header information were generated in the state shown in portion (a) or (d) of FIG. 10, then the physical sector number recorded in the sector header, although not shown, should be updated because the data storage location would change after the additional data has been inserted. That is why it is more efficient to set the scramble information after the additional data has been inserted.

Just by reading the scramble information in the sector header, the drive can determine whether or not the data in the sector that follows the header may be read. In that case, the drive would not read data that has been encrypted in response to a request from unauthorized software, thus contributing to controlling playback of a content using such unauthorized software.

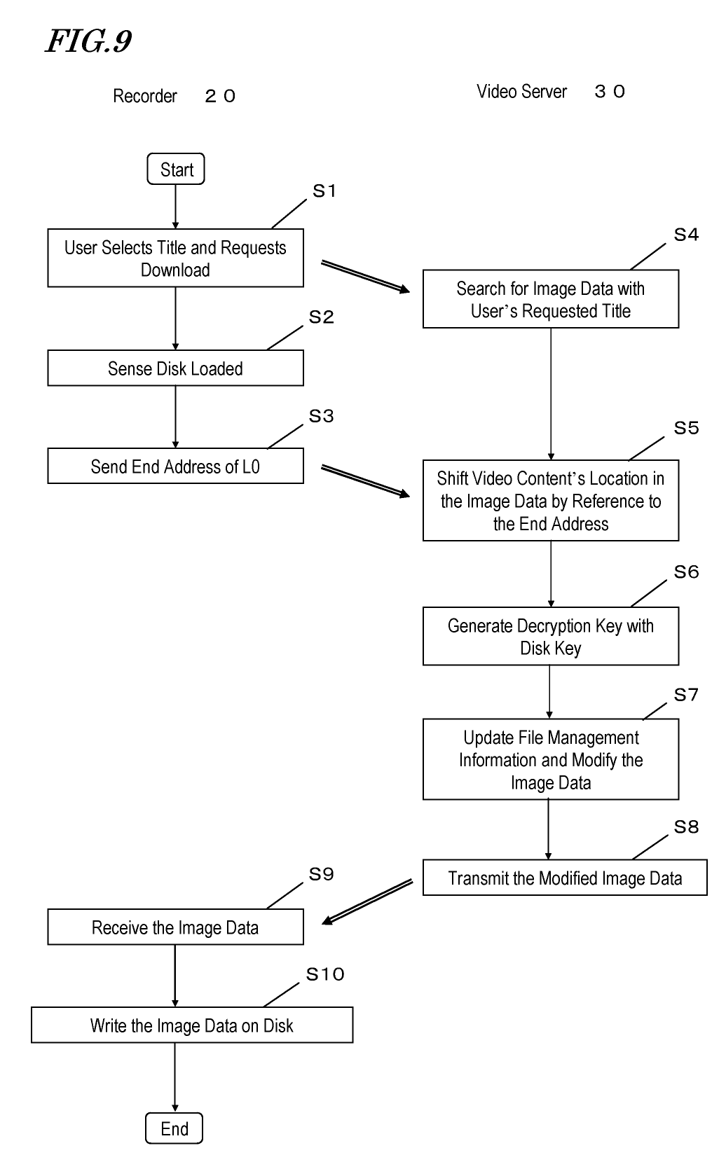

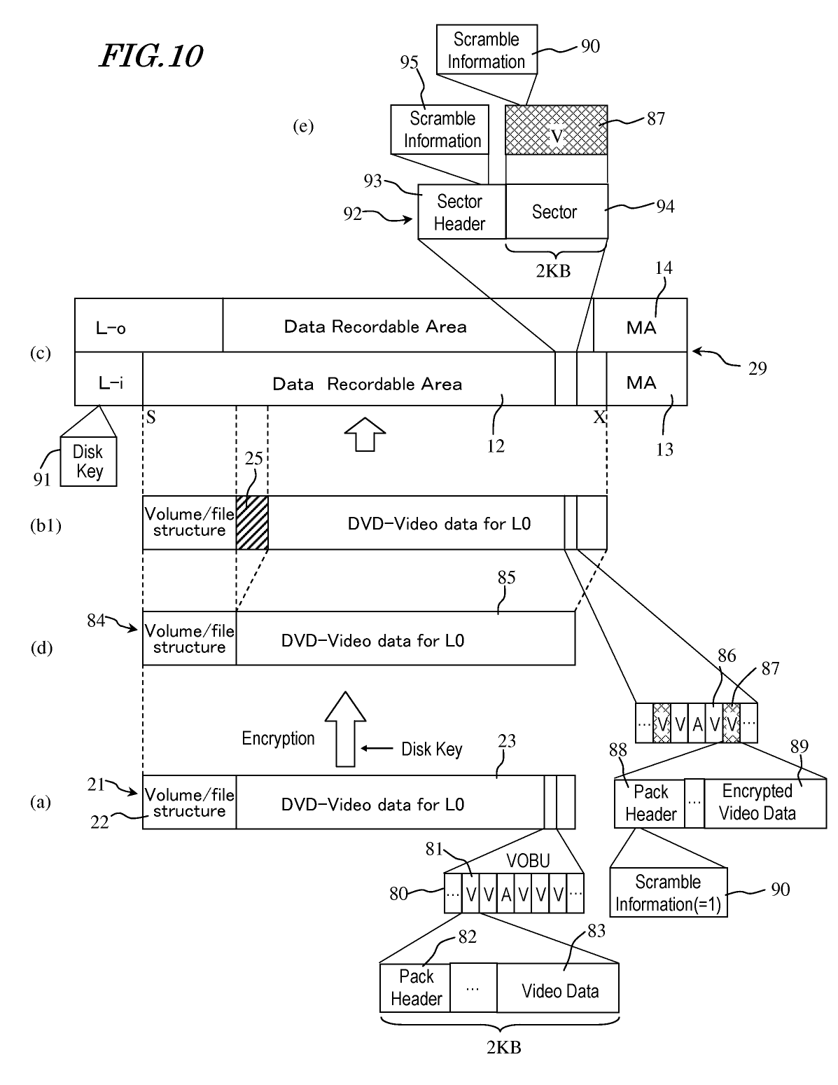

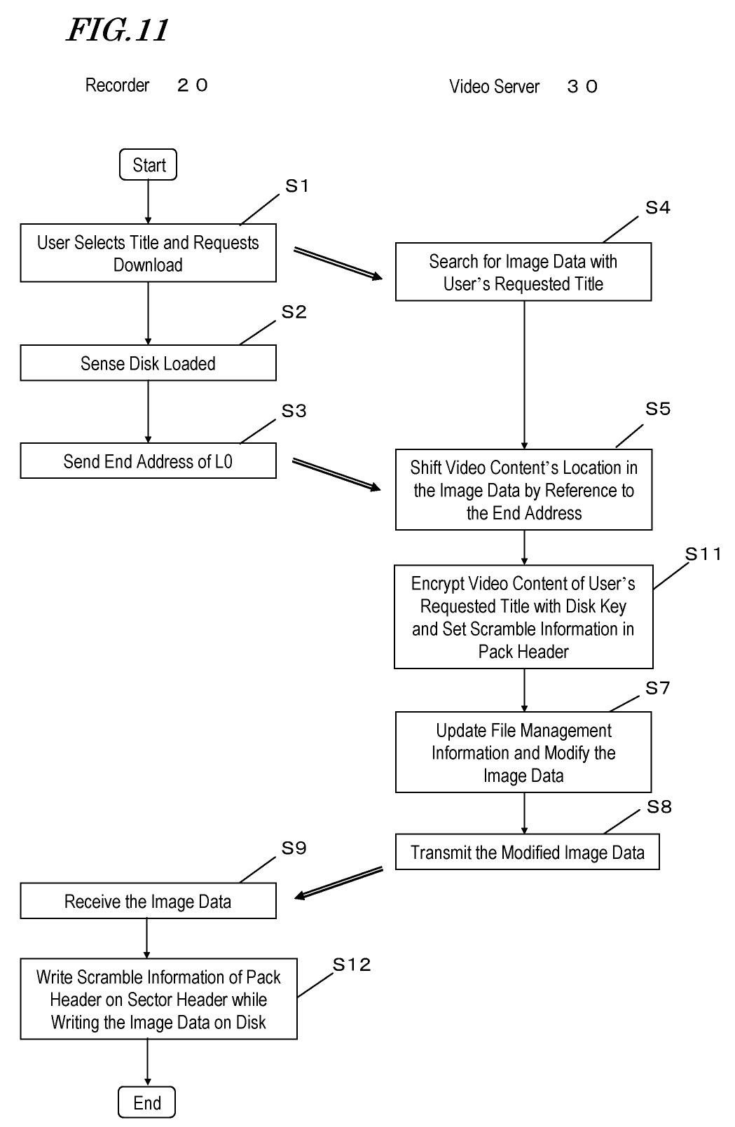

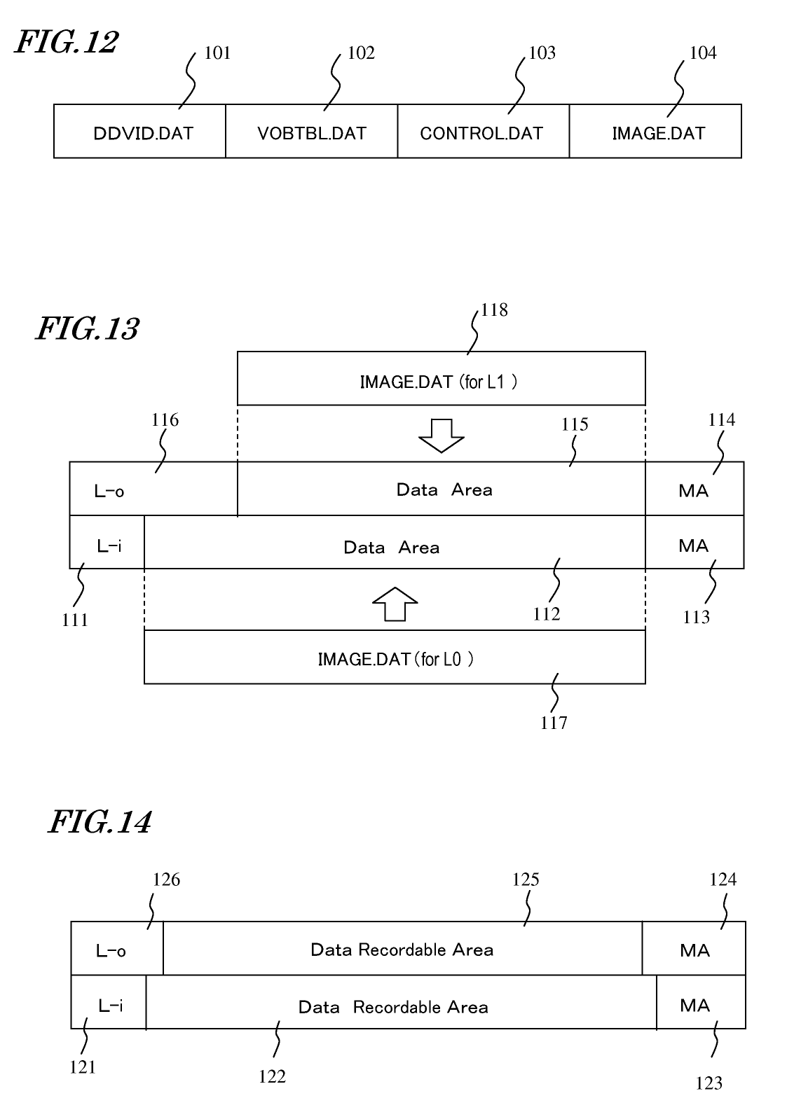

FIG. 11 shows the procedure of processing to be done by the recorder 20 and the video server 30 according to this preferred embodiment. Unlike the processing of the first preferred embodiment shown in FIG. 9, the processing shown in FIG. 11 includes processing steps S11 and S12 in place of the processing steps S6 and S10 shown in FIG. 9, respectively. Only these differences will be briefly described below.

In Step S2, when loaded with a dual layer DVD-R disk, the recorder 20 reads a disk key for use to perform CSS encryption of the dual layer DVD-R disk.

Next, in Step S3, the disk key read, as well as the end address X of the data recordable area of the L0 layer, is sent to the video server 30.

Thereafter, in Step S5 the video server 30 shifts the locations of the encrypted video content data in the image data for the L0 layer by reference to the end address X received, thereby processing the image data for the L0 layer.

Subsequently, in Step S11, using the disk key received, the video server 30 encrypts the video content data of the user's requested title by the CSS technique and sets scramble information in the pack header. According to the CSS encryption technique, the encrypted data needs to be decrypted with a disk key that has been recorded in advance on a disk. That is why the video server 30 needs to perform the CSS encryption using the disk key.

Meanwhile, in Step S12, while writing the received image data on the dual layer DVD-R disk, the recorder 20 copies the scramble information in the pack header and writes it on the sector header.

A dual layer DVD-R disk that has been produced by performing these processing steps can control the drive's encrypted data reading.

Although the present invention has been described as being applied to a dual layer disk, the present invention is also applicable for use in a multilayer disk with three or more recording layers. This is because the first and second layers that have been described for the first and second preferred embodiments of the present invention are also included in such a multilayer disk.

In receiving a service of downloading and recording a video content on a disk with multiple recording layers such as a dual layer recordable disk, the present invention provides a data processing apparatus and a recorder that can be used effectively to change the sizes of the image data efficiently and just as intended.

While the present invention has been described with respect to preferred embodiments thereof, it will be apparent to those skilled in the art that the disclosed invention may be modified in numerous ways and may assume many embodiments other than those specifically described above. Accordingly, it is intended by the appended claims to cover all modifications of the invention that fall within the true spirit and scope of the invention.

This application is based on Japanese Patent Applications No. 2006-254674 filed on Sep. 20, 2006 and No. 2007-241252 filed on Sep. 18, 2007, the entire contents of which are hereby incorporated by reference.

What is claimed is:

1. A data processing apparatus for generating data to be written continuously on first and second recording layers of a recording medium, the first and second recording layers having first and second storage capacities, respectively, the data processing apparatus comprising:
a data storage in which the data to be written is split into, and stored separately as, first and second data, the first data having a data size that is smaller than the first storage capacity, the second data having a data size that is smaller than the second storage capacity;
a communication section for getting the end address of a data recordable area of the first recording layer;
a controller for adjusting the data size of the first data such that the beginning of the first data is written at the start address of the data recordable area of the first recording layer and that the end of the first data is written at the end address gotten; and
an output section for outputting the first data, the data size of which has been adjusted, and the second data.

2. The data processing apparatus of claim 1, wherein the controller adjusts the data size of the first data by inserting additional data by reference to the end address.

3. The data processing apparatus of claim 2, wherein the start address of the data recordable area of the first recording layer has been determined in advance, and
wherein the controller inserts additional data, the data size of which is equal to a difference between the area size of the data recordable area of the first recording layer having the first storage capacity and the data size of the first data stored, the first storage capacity having been calculated based on the start and end addresses.

4. The data processing apparatus of claim 2, wherein the first data includes content data and management information for managing the location of the content data, and
wherein if the location of the content data has changed due to the insertion of the additional data, the controller updates the management information.

5. The data processing apparatus of claim 4, wherein the recording medium stores unique identification information, and
wherein the communication section gets the identification information, and
wherein the controller encrypts the content data using the identification information and generates scramble information, indicating that the content data has been encrypted, as a portion of the first data.

6. A recorder for writing data that has been received from a server on first and second recording layers of a recording medium continuously, the recorder comprising:
a communication controller for sending the end address of a data recordable area of the first recording layer to the server and receiving first data, the data size of which has been adjusted by reference to the end address, and second data; and
a drive controller for writing the first data, the data size of which has been adjusted, on the first recording layer and also writing the second data on the second recording layer.

7. The recorder of claim 6, wherein the recording medium stores unique identification information, and
wherein the communication controller transmits the identification information to the server, and then receives the first data, which has been encrypted with the identification information and the data size of which has been adjusted.

8. The recorder of claim 6, wherein a recording unit is defined for the recording medium, and
wherein the first data includes encrypted content data, scramble information indicating that the content data has been encrypted, and management information for managing the location of the content data, and
wherein the drive controller divides the encrypted content data into multiple recording units, writes the units separately, and also writes the scramble information on a header of each said recording unit.

9. The recorder of claim 6, wherein the drive controller starts writing the first data at the start address of the data recordable area of the first recording layer such that the end of the first data is written at the end address.

10. A player for reading data from a recording medium, on which the data has been written by the recorder of claim 9, comprising:
a controller that instructs when to start reading; and
a drive controller for starting reading the first data at the start address of the data recordable area of the first recording layer and also starting reading the second data at the start address of the data recordable area of the second recording layer,
wherein as the end of the first data has been written at the end address, the drive controller starts reading the second data at the start address of the data recordable area of the second recording layer that is right next to the end address.

11. A recording medium on which data has been written continuously on first and second recording layers having first and second storage capacities, respectively, and each having a data recordable area,
wherein first data starts to be written at the start address of the data recordable area of the first recording layer and the end of the first data is written at the end address thereof, and
wherein second data starts to be written at the start address of the data recordable area of the second recording layer,
wherein the first data includes data for adjusting the data length of the first data.
